(19) United States
(12) Patent Application Publication
(10) Pub. No.: US 2014/0265544 A1
(43) Pub. Date: Sep. 18, 2014

(54) Vehicle Brake System With Plunger Assembly

(71) Applicant: KELSEY-HAYES COMPANY, (US)

(72) Inventor: Blaise J. Ganzel, Ann Arbor, MI (US)

(73) Assignee: KELSEY-HAYES COMPANY, Livonia, MI (US)

(21) Appl. No.: 13/843,485

(22) Filed: Mar. 15, 2013

(51) Int. Cl. B60T 13/58; B60T 13/68

(52) U.S. Cl. CPC B60T 13/588; B60T 13/686
USPC 303/6.01

(57) ABSTRACT

A brake system includes a plunger assembly for actuating wheel brakes during a normal brake apply. The plunger assembly includes a motor mounted on the housing for driving an actuator. A first piston is connected to the actuator. The first piston is slidably mounted within the housing for pressurizing a first fluid chamber in the housing. A second piston is slidably mounted within the housing for pressurizing a second fluid chamber in the housing. A pump-less control valve arrangement includes a first control valve regulating the flow of fluid between a first fluid chamber and the first wheel brake. A second control valve regulates the flow of fluid between a second fluid chamber and the second wheel brake. An isolation valve arrangement switches the brake system between the normal braking mode and the manual push-through mode.

### BACKGROUND OF THE INVENTION

This invention relates in general to vehicle braking systems. Vehicles are commonly slowed and stopped with hydraulic brake systems. These systems vary in complexity but a base brake system typically includes a brake pedal, a tandem master cylinder, fluid conduits arranged in two similar but separate brake circuits, and wheel brakes in each circuit. The driver of the vehicle operates a brake pedal which is connected to the master cylinder. When the brake pedal is depressed, the master cylinder generates hydraulic forces in both brake circuits by pressurizing brake fluid. The pressurized fluid travels through the fluid conduit in both circuits to actuate brake cylinders at the wheels to slow the vehicle.

Base brake systems typically use a brake booster which provides a force to the master cylinder which assists the pedal force created by the driver. The booster can be vacuum or hydraulically operated. A typical hydraulic booster senses the movement of the brake pedal and generates pressurized fluid which is introduced into the master cylinder. The fluid from the booster assists the pedal force acting on the pistons of the master cylinder which generate pressurized fluid in the conduit in fluid communication with the wheel brakes. Thus, the pressures generated by the master cylinder are increased. Hydraulic boosters are commonly located adjacent the master cylinder piston and use a boost valve to control the pressurized fluid applied to the booster.

Braking a vehicle in a controlled manner under adverse conditions requires precise application of the brakes by the driver. Under these conditions, a driver can easily apply excessive braking pressure thus causing one or more wheels to lock, resulting in excessive slippage between the wheel and road surface. Such wheel lock-up conditions can lead to greater stopping distances and possible loss of directional control.

Advances in braking technology have led to the introduction of Anti-lock Braking Systems (ABS). An ABS system monitors wheel rotational behavior and selectively applies and relieves brake pressure in the corresponding wheel brakes in order to maintain the wheel speed within a selected slip range to achieve maximum braking force. While such systems are typically adapted to control the braking of each braked wheel of the vehicle, some systems have been developed for controlling the braking of only a portion of the plurality of braked wheels.

Electronically controlled ABS valves, comprising apply valves and dump valves, are located between the master cylinder and the wheel brakes. The ABS valves regulate the pressure between the master cylinder and the wheel brakes. Typically, when activated, these ABS valves operate in three pressure control modes: pressure apply, pressure dump and pressure hold. The apply valves allow pressurized brake fluid into respective ones of the wheel brakes to increase pressure during the apply mode, and the dump valves relieve brake fluid from their associated wheel brakes during the dump mode. Wheel brake pressure is held constant during the hold mode by closing both the apply valves and the dump valves.

To achieve maximum braking forces while maintaining vehicle stability, it is desirable to achieve optimum slip levels at the wheels of both the front and rear axles. During vehicle deceleration different braking forces are required at the front and rear axles to reach the desired slip levels. Therefore, the brake pressures should be proportioned between the front and rear brakes to achieve the highest braking forces at each axle. ABS systems with such ability, known as Dynamic Rear Proportioning (DRP) systems, use the ABS valves to separately control the braking pressures on the front and rear wheels to dynamically achieve optimum braking performance at the front and rear axles under the then current conditions.

A further development in braking technology has led to the introduction of Traction Control (TC) systems. Typically, valves have been added to existing ABS systems to provide a brake system which controls wheel speed during acceleration. Excessive wheel speed during vehicle acceleration leads to wheel slippage and a loss of traction. An electronic control system senses this condition and automatically applies braking pressure to the wheel cylinders of the slipping wheel to reduce the slippage and increase the traction available. In order to achieve optimal vehicle acceleration, pressurized brake fluid is made available to the wheel cylinders even if the master cylinder is not actuated by the driver.

During vehicle motion such as cornering, dynamic forces are generated which can reduce vehicle stability. A Vehicle Stability Control (VSC) brake system improves the stability of the vehicle by counteracting these forces through selective brake actuation. These forces and other vehicle parameters are detected by sensors which signal an electronic control unit. The electronic control unit automatically operates pressure control devices to regulate the amount of hydraulic pressure applied to specific individual wheel brakes. In order to achieve optimal vehicle stability, braking pressures greater than the master cylinder pressure must quickly be available at all times.

Brake systems may also be used for regenerative braking to recapture energy. An electromagnetic force of an electric motor/generator is used in regenerative braking for providing a portion of the braking torque to the vehicle to meet the braking needs of the vehicle. A control module in the brake system communicates with a powertrain control module to provide coordinated braking during regenerative braking as well as braking for wheel lock and skid conditions. For example, as the operator of the vehicle begins to brake during regenerative braking, electromagnet energy of the motor/generator will be used to apply braking torque (i.e., electromagnetic resistance for providing torque to the powertrain) to the vehicle. If it is determined that there is no longer a sufficient amount of storage means to store energy recovered from the regenerative braking or if the regenerative braking cannot meet the demands of the operator, hydraulic braking will be activated to complete all or part of the braking action demanded by the operator. Preferably, the hydraulic braking operates in a regenerative brake blending manner so that the blending is effectively and unnoticeably picked up where the electromagnetic braking left off. It is desired that the vehicle movement should have a smooth transitional change to the hydraulic braking such that the changeover goes unnoticed by the driver of the vehicle.

Some braking systems are configured such that the pressures at each of the wheel brakes can be controlled independently (referred to as a multiplexing operation) from one another even though the brake system may includes a single source of pressure. Thus, valves downstream of the pressure source are controlled between their open and closed positions to provide different braking pressures within the wheel brakes. Such multiplex systems, which are all incorporated by reference herein, are disclosed in U.S. Pat. No. 8,038,229, U.S. Patent Application Publication No. 2010/0026083, U.S. Patent Application Publication No. 2012/0013173, and U.S. Patent Application Publication No. 2012/0306261.

### SUMMARY OF THE INVENTION

This invention relates to vehicle brake systems such as a brake system including first and second wheel brakes and a brake pedal unit including a housing and a pair of output pistons slidably disposed in the housing. The pair of output pistons are movable to generate brake actuating pressure at first and second outputs for actuating the first and second wheel brakes, respectively, during a manual push through mode. A plunger assembly for actuating the first and second wheel brakes during a normal brake apply includes a housing and a motor mounted on the housing for driving an actuator. A first piston is connected to the actuator. The first piston is slidably mounted within the housing for pressurizing a first fluid chamber in the housing. The first fluid chamber is in communication with the first wheel brake. A second piston is slidably mounted within the housing for pressurizing a second fluid chamber in the housing. The second fluid chamber is in communication with the second wheel brake. A pump-less control valve arrangement includes a first control valve regulating the flow of fluid between the first fluid chamber and the first wheel brake. A second control valve regulates the flow of fluid between the second fluid chamber and the second wheel brake. An isolation valve arrangement switches the brake system between the normal braking mode wherein boost pressure from the plunger assembly is supplied to the wheel brakes, and the manual push-through mode wherein brake actuating pressure from the brake pedal unit is supplied to the wheel brakes.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a first embodiment of a brake system.

FIG. 2 is an enlarged schematic sectional view of the brake pedal unit assembly of the brake system of FIG. 1 shown in its rest position.

FIG. 3 is an enlarged schematic sectional view of the plunger assembly of the brake system of FIG. 1 shown in its rest position.

FIG. 4 is a schematic illustration of a second embodiment of a brake system.

FIG. 5 is an enlarged schematic sectional view of the plunger assembly of the brake system of FIG. 4 shown in its rest position.

FIG. 6 is a cross-sectional view of a third embodiment of a plunger assembly which may be used in the brake system of FIG. 5, wherein the plunger assembly is shown in a rest position.

FIG. 7 is a cross-sectional view of a plunger assembly of FIG. 6 shown in a full stroke position.

FIG. 8 is a cross-sectional view of a fourth embodiment of plunger assembly.

### DETAILED DESCRIPTION OF THE PREFERRED EMBODIMENT

Referring now to the drawings, there is schematically illustrated in FIG. 1 a first embodiment of a vehicle brake system, indicated generally at 10. The brake system 10 is a hydraulic boost braking system in which boosted fluid pressure is utilized to apply braking forces for the brake system 10. The brake system 10 may suitably be used on a ground vehicle such as an automotive vehicle having four wheels with a wheel brake associated with each wheel. Furthermore, the brake system 10 can be provided with other braking functions such as anti-lock braking (ABS) and other slip control features to effectively brake the vehicle, as will be discussed below.

The brake system 10 generally includes a first block or brake pedal unit assembly, indicated by broken lines 12, and a second block or hydraulic control unit, indicated by broken lines 14. The various components of the brake system 10 are housed in the brake pedal unit assembly 12 and the hydraulic control unit 14. The brake pedal unit assembly 12 and the hydraulic control unit 14 may include one or more blocks or housings made from a solid material, such as aluminum, that has been drilled, machined, or otherwise formed to house the various components. Fluid conduits may also be formed in the housings to provide fluid passageways between the various components. The housings of the brake pedal unit assembly 12 and the hydraulic control unit 14 may be single structures or may be made of two or more parts assembled together. As schematically shown, the hydraulic control unit 14 is located remotely from the brake pedal unit assembly 12 with hydraulic lines hydraulically coupling the brake pedal unit assembly 12 and the hydraulic control unit 14. Alternatively, the brake pedal unit assembly 12 and the hydraulic control unit 14 may be housed in a single housing. It should also be understood that the grouping of components as illustrated in FIG. 1 is not intended to be limiting and any number of components may be housed in either of the housings.

The brake pedal unit assembly 12 cooperatively acts with the hydraulic control unit 14 for actuating wheel brakes 16a, 16b, 16c, and 16d. The wheel brakes 16a, 16b, 16c, and 16d can be any suitable wheel brake structure operated by the application of pressurized brake fluid. The wheel brake 16a, 16b, 16c, and 16d may include, for example, a brake caliper mounted on the vehicle to engage a frictional element (such as a brake disc) that rotates with a vehicle wheel to effect braking of the associated vehicle wheel. The wheel brakes 16a, 16b, 16c, and 16d can be associated with any combination of front and rear wheels of the vehicle in which the brake system 10 is installed. For example, for a vertically split system, the wheel brakes 16a and 16d may be associated with the wheels on the same axle. For a diagonally split brake system, the wheel brakes 16a and 16b may be associated with the front wheel brakes.

The brake pedal unit assembly 12 includes a fluid reservoir 18 for storing and holding hydraulic fluid for the brake system 10. The fluid within the reservoir 18 may be held generally at atmospheric pressure or can store the fluid at other pressures if so desired. The brake system 10 may include a fluid level sensor 19 for detecting the fluid level of the reservoir. The fluid level sensor 19 may be helpful in determining whether a leak has occurred in the system 10.

The brake pedal control unit assembly 12 includes a brake pedal unit (BPU), indicated generally at 20. The brake pedal unit 20 is also schematically shown enlarged in FIG. 2. It should be understood that the structural details of the components of the brake pedal unit 20 illustrate only one example of a brake pedal unit 20. The brake pedal unit 20 could be configured differently having different components than that shown in FIGS. 1 and 2.

The brake pedal unit 20 includes a housing 24 (shown broken away in FIG. 2) having various bores formed in for slidably receiving various cylindrical pistons and other components therein. The housing 24 may be formed as a single unit or include two or more separately formed portions coupled together. The housing 24 generally includes a first bore 26, an intermediate second bore 28, and a third bore 30. The second bore 28 has a larger diameter than the first bore 26 and the third bore 30. The brake pedal unit 20 further includes an input piston 34, a primary piston 38, and a secondary piston 40. The input piston 34 is slidably disposed in the first bore 26. The primary piston 38 is slidably disposed in the second bore 28. The secondary piston 40 is slidably disposed in the third bore 30.

A brake pedal, indicated schematically at 42 in FIGS. 1 and 2, is coupled to a first end 44 of the input piston 34 via an input rod 45. The input rod 45 can be coupled directly to the input piston 34 or can be indirectly connected through a coupler (not shown). The input piston 34 includes an enlarged second end 52 that defines a shoulder 54. In the rest position shown in FIGS. 1 and 2, the shoulder 54 of the input piston engages with a shoulder 56 formed between the first and second bores 26 and 28 of the housing 24. An outer cylindrical surface 57 of the input piston 34 is engaged with a seal 58 and a lip seal 60 mounted in grooves formed in the housing 24. The outer cylindrical surface 57 may be continuous along its length or it may be stepped having two or more different diameter portions. The input piston 34 includes a central bore 62 formed through the second end 52. One or more lateral passageways 64 are formed through the input piston 34. The lateral passageways 64 extend from the outer cylindrical surface 57 to the central bore 62 to provide fluid communication therebetween. The brake pedal unit 20 is in a “rest” position as shown in FIGS. 1 and 2. In the “rest” position, the pedal 42 has not been depressed by the driver of the vehicle. In the rest position, the passageways 64 of the input piston 34 are between the seals 58 and 60. In this position, the passageways 64 are in fluid communication with a conduit 66 formed though the housing 24. The conduit 66 is in fluid communication with a conduit 68 formed in the housing 24. The conduit 68 is in fluid communication with a reservoir port 70 connected to the reservoir 18. A filter 69 may be disposed in the port 70 or the conduit 68. The conduits 66 and 68 can be formed by various bores, grooves and passageways formed in the housing 24. In the rest position, the passageways 64 are also in fluid communication with a conduit 72 formed in the housing 24 which leads to a simulation valve 74. The simulation valve 74 may be a cut off valve which may be electrically operated. The simulation valve 74 may be mounted in the housing 24 or may be remotely located therefrom

The primary piston 38 is slidably disposed in the second bore 28 of the housing 24. An outer wall 79 of the primary piston 38 is engaged with a lip seal 80 and a lip seal 81 mounted in grooves formed in the housing 24. The primary piston 38 includes a first end 82 having a cavity 84 formed therein. A second end 86 of the primary piston 38 includes a cavity 88 formed therein. One or more passageways 85 are formed in the primary piston 38 which extend from the cavity 88 to the outer wall of the primary piston 38. As shown in FIG. 2, the passageway 85 is located between the lip seals 80 and 81 when the primary piston 38 is in its rest position. For reasons which will be explained below, the passageway 85 is in selective fluid communication with a conduit 154 which is in fluid communication with the reservoir 18.

The central bore 62 of the input piston 34 and the cavity 84 of the primary piston 38 house various components defining a pedal simulator, indicated generally at 100. A caged spring assembly, indicated generally at 102, is defined by a pin 104, a retainer 106, and a low rate simulator spring 108. The pin 104 is shown schematically as being part of the input piston 34 and disposed in the central bore 62. The pin 104 could be configured as a pin having a first end which is press fit or threadably engaged with the input piston 34. The pin 104 extends axially within the central bore 62 and into the cavity 84 of the primary piston 38. A second end 112 of the pin 104 includes a circular flange 114 extending radially outwardly therefrom. The second end 112 is spaced from an elastomeric pad 118 disposed in the cavity 84. The elastomeric pad 118 is axially aligned with the second end 112 of the pin 104, the reason for which will be explained below. The retainer 106 of the caged spring assembly 102 includes a stepped through bore 122. The stepped through bore 122 defines a shoulder 124. The second end 112 of the pin 104 extends through the through bore 122. The flange 114 of the pin 104 engages with the shoulder 124 of the retainer 106 to prevent the pin 104 and the retainer 106 from separating from each other. One end of the low rate simulator spring 108 engages with the second end 52 of the input piston 34, and the other end of the low rate simulator spring 108 engages with the retainer 106 to bias the retainer 106 in a direction away from the pin 104.

The pedal simulator 100 further includes a high rate simulator spring 130 which is disposed about the pin 104. The terms low rate and high rate are used for description purposes and are not intended to be limiting. It should be understood that that the various springs of the pedal simulator 100 may have any suitable spring coefficient or spring rate. In the illustrated embodiment, the high rate simulator spring 130 preferably has a higher spring rate than the low rate simulator spring 108. One end of the high rate simulator spring 130 engages with the bottom of the central bore 62 of the input piston 34. The other end of the high rate simulator spring 130 is shown in FIG. 2 in a non-engaged position and spaced away from an end of the retainer 106. The housing 24, the input piston 34 (and its seals), and the primary piston 38 (and its seals) generally define a fluid simulation chamber 144. The simulation chamber 144 is in fluid communication with a conduit 146 which is in fluid communication with the simulation valve 74. A filter 145 may be housed within the conduit 146.

As discussed above, the brake pedal unit 20 includes the primary and secondary pistons 38 and 40 that are disposed in the second and third bores 28 and 32, respectively, which are formed in the housing 24. The primary and secondary pistons 38 and 40 are generally coaxial with one another. A primary output conduit 156 is formed in the housing 24 and is in fluid communication with the second bore 28. The primary output conduit 156 may be extended via external piping or a hose connected to the housing 24. A secondary output conduit 166 is formed in the housing 24 and is in fluid communication with the third bore 30. The secondary output conduit 166 may be extended via external piping or a hose connected to the housing 24. As will be discussed in detail below, rightward movement of the primary and secondary pistons 38 and 40, as viewing FIGS. 1 and 2, provides pressurized fluid out through the conduits 156 and 166, respectively. A return spring 151 is housed in the second bore 28 and biases the primary piston 38 in the leftward direction.

The secondary piston 40 is slidably disposed in the third bore 30. An outer wall 152 of the secondary piston is engaged with a lip seal 153 and a lip seal 154 mounted in grooves formed in the housing 24. A secondary pressure chamber 228 is generally defined by the third bore 30, the secondary piston 40, and the lip seal 154. Rightward movement of the secondary piston 40, as viewing FIGS. 1 and 2, causes a buildup of pressure in the secondary pressure chamber 228. The secondary pressure chamber 228 is in fluid communication with the secondary output conduit 166 such that pressurized fluid is selectively provided to the hydraulic control unit 14. One or more passageways 155 are formed in the secondary piston 40. The passageway 155 extends between the outer wall of the primary piston 38 and a right-hand end of the secondary piston 40. As shown in FIG. 2, the passageway 155 is located between the seal 153 and the lip seal 154 when the secondary piston 40 is in its rest position, the reason for which will be explained below. For reasons which will be explained below, the passageway 155 is in selective fluid communication with a conduit 164 which is in fluid communication with the reservoir 18.

A primary pressure chamber 198 is generally defined by the second bore 28, the primary piston 38, the secondary piston 40, the lip seal 81, and the seal 153. Although the various seals shown in the drawings are schematically represented as O-ring or lip seals, it should be understood that they can have any configuration. Rightward movement of the primary piston 38, as viewing FIGS. 1 and 2, causes a buildup of pressure in the primary pressure chamber 198. The primary pressure chamber 198 is in fluid communication with the primary output conduit 156 such that pressurized fluid is selectively provided to the hydraulic control unit 14.

The primary and secondary pistons 38 and 40 may be mechanically connected together such that there is limited play or movement between the pistons 38 and 40. This type of connection permits the primary and secondary pistons 38 and 40 to move relative to one another by relatively small increments to compensate for pressure and/or volume differences in their respective output circuits. However, under certain failure modes it is desirable that the secondary piston 40 is connected to the primary piston 38. For example, if the brake system 10 is under a manual push through mode, as will be explained in detail below, and additionally fluid pressure is lost in the output circuit relative to the secondary piston 40, such as for example, in the conduit 166, the secondary piston 40 will be forced or biased in the rightward direction due to the pressure within the primary chamber 1798. If the primary and secondary pistons 38 and 40 were not connected together, the secondary piston 40 would freely travel to its further most right-hand position, as viewing FIGS. 1 and 2, and the driver would have to depress the pedal 42 a distance to compensate for this loss in travel. However, because the primary and secondary pistons 38 and 40 are connected together, the secondary piston 40 is prevented from this movement and relatively little loss of travel occurs in this type of failure.

The primary and secondary pistons 38 and 40 can be connected together by any suitable manner. For example, as schematically shown in FIGS. 1 and 2, a locking member 180 is disposed and trapped between the primary and secondary pistons 38 and 40. The locking member 180 includes a first end 182 and a second end 184. The first end 182 is trapped within the cavity 88 of the second end 86 of the primary piston 38. The second end 184 of the locking member 180 is trapped within a recess or cavity 186 formed in the secondary piston 40. The first and second ends 182 and 184 may include enlarged head portions which are trapped behind narrower openings 192 and 194 of the cavities 88 and 186, respectively. A first spring 188 is housed within the cavity 88 of the primary piston 38 and biases the locking member 180 in a direction towards the primary piston 38 and away from the secondary piston 40. A second spring 190 is housed within the cavity 186 of the secondary piston 40 and biases the locking member 180 in a direction towards the primary piston 38 and away from the secondary piston 40. The springs 188 and 190 and the locking member 180 maintain the first and second output piston at a spaced apart distance from one another while permitting limited movement towards and away from each other by compression of the springs 188 or 190. This limited play mechanical connection permits the primary and secondary pistons 38 and 40 to move relative to one another by small increments to compensate for pressure and/or volume differences in their respective output circuits.

Referring back to FIG. 1, the system 10 may further include a travel sensor, schematically shown at 240 in FIG. 1, for producing a signal that is indicative of the length of travel of the input piston 34 which is indicative of the pedal travel. The system 10 may also include a switch 252 for producing a signal for actuation of a brake light and to provide a signal indicative of movement of the input piston 34. The brake system 10 may further include sensors such as pressure transducers 257 and 259 for monitoring the pressure in the conduits 156 and 166, respectively.

The system 10 further includes a source of pressure in the form of a plunger assembly, indicated generally at 300. As will be explained in detail below, the system 10 uses the plunger assembly 300 to provide a desired pressure level to each of the wheel brakes 16a-d. Fluid from the wheel brakes 16a-d is returned to the plunger assembly 300.

The system 10 further includes a first isolation valve 302 and a second isolation valve 304 (or referred to as switching valves or switching valve arrangement). The isolation valves 302 and 304 may be solenoid actuated valves. The isolation valves 302 and 304 are generally operable between an open position 302a, as schematically shown in FIG. 1, and a closed position 302b. The first isolation valve 302 is in fluid communication with the primary output conduit 156 such that when the first isolation valve 302 is in its open position 302a, fluid flow is permitted between the first output pressure chamber 198 and the plunger assembly 300 via the primary output conduit 156 and a conduit 306. When the first isolation valve 302 is in its closed position 302b, fluid flow is restricted from flowing though the primary output conduit 156 to the conduit 306. The second isolation valve 304 is in fluid communication with the secondary output conduit 166 such that when the second isolation valve 304 is in its open position 304a, fluid flow is permitted between the second output pressure chamber 228 and the plunger assembly 300 via the secondary output conduit 166 and a conduit 308. When the second isolation valve 304 is in its closed position 304b, fluid flow is restricted from flowing though the secondary output conduit 166 to the conduit 308.

The system 10 may further include various valves, such as a slip control valve arrangement, for permitting controlled braking operations, such as ABS, traction control, vehicle stability control, and regenerative braking blending. In the embodiment shown in FIG. 1, the system 10 includes first, second, third, and fourth control valves 310, 312, 314, and 316. Similar to the isolation valves 302 and 304, the control valves 310, 312, 314, and 316 may be solenoid actuated valves movable between open and closed positions and constructed to permit high pressure fluid to flow in both directions through the valve. The control valve 310 is in fluid communication with the plunger assembly 300 via conduit 320. The control valve 310 is also in fluid communication with the wheel brake 16a via a wheel conduit 322. The control valve 312 is in fluid communication with the plunger assembly 300 via conduit 324. The control valve 312 is also in fluid communication with the wheel brake 16b via a wheel conduit 326. The control valve 314 is in fluid communication with the plunger assembly 300 via the conduit 324. The control valve 314 is also in fluid communication with the wheel brake 16b via a wheel conduit 328. The control valve 316 is in fluid communication with the plunger assembly 300 via the conduit 320. The control valve 316 is also in fluid communication with the wheel brake 16b via a wheel conduit 328. A pressure transducer 321 or other sensor may be included in the system 10 to monitor the pressure within the conduit 320. The system 10 may also include a pressure transducer or sensor (not shown) to monitor the pressure within the conduit 324.

As stated above, the system 10 includes a source of pressure in the form of the plunger assembly 300 to provide a desired pressure level to each of the wheel brakes 16a-d. As best shown in FIG. 3, the plunger assembly 300 includes a housing 340 having a bore 342 formed therein. Slidably disposed in the bore 342 are first and second pistons 344 and 346, respectively. The plunger assembly 300 further includes a ball screw mechanism, indicated generally at 350. The ball screw mechanism 350 is provided to impart translational or linear motion of the first piston 344 along an axis defined by the bore 342 in both an actuation direction (leftward as viewing FIGS. 1 and 3), and a retraction direction (rightward as viewing FIGS. 1 and 3) within the bore 342 of the housing 340. In the embodiment shown, the ball screw mechanism 350 includes a motor 352 rotatably driving a screw shaft 354. A motor 352 may include a sensor 353 for detecting the rotational position of the motor 352 and/or ball screw mechanism 350 which is indicative of the position of the first piston 344. This may be particular useful for a motor 352 which is capable of very accurate control including controlling the motor to minute movements for providing multiplex control as will be described below. The first piston 344 includes a threaded bore 356 and functions as a driven nut of the ball screw mechanism 350. The ball screw mechanism 350 includes a plurality of balls 358 that are retained within helical raceways formed in the screw shaft 354 and the threaded bore 356 of the first piston 344 to reduce friction. Although a ball screw mechanism 350 is shown and described with respect to the plunger assembly 300, it should be understood that other suitable mechanical linear actuators may be used for imparting movement of the first piston 344. It should also be understood that although the first piston 344 functions as the nut of the ball screw mechanism 250, the first piston 344 could be configured to function as a screw shaft of the ball screw mechanism 350. Of course, under this circumstance, the screw shaft 354 would be configured to function as a nut having internal helical raceways formed therein.

The first piston 344 includes an outer cylindrical surface 360. An O-ring 362 is mounted within a groove 364 formed in the bore 342. A lip seal 366 is mounted within a groove 368 formed in the bore 342. The O-ring 362 and the lip seal 366 sealingly engage with the outer cylindrical surface 360 of the first piston 344. The first piston 344 includes a pin or an extension 370 extending towards the second piston 346. The extension 370 includes an enlarged head 372. The enlarged head 372 is trapped within a cavity 374 formed in the second piston 356 by an inwardly extending flange 376. The first piston 344 is mechanically connected to the second piston 346 by the cooperation of the extension 370 and the flange 376 while still permitting a predetermined amount of movement therebetween. The first piston 344 is biased in a direction away from the second piston 346 by a spring 380. The spring 380 generally acts on end surfaces of the pistons 344 and 346 which face one another. The spring 380 can be generally housed within a recess 382 formed in the first piston 344.

The second piston 346 includes an outer cylindrical surface 384. An O-ring 386 is mounted within a groove 387 formed in the bore 342. A lip seal 388 is mounted within a groove 389 formed in the bore 342. The O-ring 386 and the lip seal 388 sealingly engages with the outer cylindrical surface 384 of the second piston 346. It should be understood that any suitable sealing structure may be used for the O-rings 362 and 386 and the lip seals 366 and 388. The second piston 346 includes a pin or an extension 390 extending towards the end of the bore 342. The extension 390 includes an enlarged head 392. The enlarged head 392 is trapped within a cavity 394 formed in the end of the bore 342 of the housing 340 by an inwardly extending flange 396. The second piston 346 is mechanically connected to the housing 340 by the cooperation of the extension 390 and the flange 396 while still permitting a predetermined amount of movement therebetween. The second piston 346 is biased in a direction away from the end of the bore 340 (and towards the first piston 344, by a spring 400. The spring 400 can be generally housed within a recess 402 formed in the second piston 346. The springs 380 and 400 generally position the second piston 346 relative to the first piston 344 within the bore 342. The springs 380 and 400 also function as return springs by biasing the first and second pistons 344 and 346 into their rest positions as shown in FIGS. 1 and 3.

The plunger assembly 300 includes a first pressure chamber 410 and a second pressure chamber 412. The first pressure chamber 410 is generally defined by the bore 340, the first and second pistons 344 and 346, the lip seal 366, and the O-ring 386. The first pressure chamber 410 communicates with the conduit 308 which is in selective communication with the secondary output conduit 166 via the second isolation valve 304. The first pressure chamber 410 is also in fluid communication with the conduit 324 which is in selective fluid communication with the wheel brakes 16b and 16c via the control valves 312 and 314. The second pressure chamber 412 is generally defined by the bore 340, the second piston 346, and the lip seal 388. The second pressure chamber 412 communicates with the conduit 306 which is in selective communication with the primary output conduit 156 via the first isolation valve 302. The second pressure chamber 412 is also in fluid communication with the conduit 320 which is in selective fluid communication with the wheel brakes 16a and 16d via the control valves 310 and 316.

The gap between the O-ring 362 and the lip seal 366 is vented or in fluid communication with the reservoir 18 via the conduit 296. Similarly, the gap between the O-ring 386 and the lip seal 388 is vented or in fluid communication with the reservoir 18 via the conduit 296.

As stated above, the brake pedal unit assembly 12 includes a simulation valve 74 which may be mounted in the housing 24 or remotely from the housing 24. As schematically shown in FIGS. 1 and 2, the simulation valve 74 may be a solenoid actuated valve. The simulation valve 74 includes a first port 75 and a second port 77. The port 75 is in fluid communication with the conduit 146 which is in fluid communication with the simulation chamber 144. The port 77 is in fluid communication with the conduit 72 which is in fluid communication with the reservoir 18 via the conduits 66 and 68. The simulation valve 74 is movable between a first position 74a restricting the flow of fluid from the simulation chamber 144 to the reservoir 18, and a second position 74b permitting the flow of fluid between the reservoir 18 and the simulation chamber 144. The simulation valve 74 is in the first position or normally closed position when not actuated such that fluid is prevented from flowing out of the simulation chamber 144 through conduit 72, as will be explained in detail below.

The following is a description of the operation of the brake system 10. FIGS. 1 and 2 illustrate the brake system 10 and the brake pedal unit 20 in the rest position. In this condition, the driver is not depressing the brake pedal 42. Also in the rest condition, the simulation valve 74 may be energized or not energized. During a typical braking condition, the brake pedal 42 is depressed by the driver of the vehicle. The brake pedal 42 is coupled to the travel sensor 240 for producing a signal that is indicative of the length of travel of the input piston 34 and providing the signal to an electronic control module (not shown). The control module may include a microprocessor. The control module receives various signals, processes signals, and controls the operation of various electrical components of the brake system 10 in response to the received signals. The control module can be connected to various sensors such as pressure sensors, travel sensors, switches, wheel speed sensors, and steering angle sensors. The control module may also be connected to an external module (not shown) for receiving information related to yaw rate, lateral acceleration, longitudinal acceleration of the vehicle such as for controlling the brake system 10 during vehicle stability operation. Additionally, the control module may be connected to the instrument cluster for collecting and supplying information related to warning indicators such as ABS warning light, brake fluid level warning light, and traction control/vehicle stability control indicator light.

During normal braking operations (normal boost apply braking operation) the plunger assembly 300 is operated to provide boost pressure to the conduit 320 and 324 for actuation of the wheel brakes 16a-d. Under certain driving conditions, the control module communicates with a powertrain control module (not shown) and other additional braking controllers of the vehicle to provide coordinated braking during advanced braking control schemes (e.g., anti-lock braking (AB), traction control (TC), vehicle stability control (VSC), and regenerative brake blending). During a normal boost apply braking operation, the flow of pressurized fluid from the brake pedal unit 20 generated by depression of the brake pedal 42 is diverted into the internal pedal simulator assembly 100. The simulation valve 74 is actuated to divert fluid through the simulation valve 74 from the simulation chamber 144 to the reservoir 18 via the conduits 146, 72, 66, and 68. Note that fluid flow from the simulation chamber 144 to the reservoir 18 is closed off once the passageways 64 in the input piston 34 move past the seal 60. Prior to movement of the input piston 34, as shown in FIGS. 1 and 2, the simulation chamber 144 is in fluid communication with the reservoir 18 via the conduits 66 and 68.

During the duration of the normal braking mode, the simulation valve 74 remains open permitting the fluid to flow from the simulation chamber 144 to the reservoir 18. The fluid within the simulation chamber 144 is non-pressurized and is under very low pressures, such as atmospheric or low reservoir pressure. This non-pressurized configuration has an advantage of not subjecting the sealing surfaces of the pedal simulator to large frictional forces from seals acting against surfaces due to high pressure fluid. In conventional pedal simulators, the piston(s) are under increasingly high pressures as the brake pedal is depressed subjecting them large frictional forces from the seals, thereby adversely effecting the pedal feel.

Also during the normal boost apply braking operation, the first and second isolation valves 302 and 304 are energized to their closed positions 302b and 304b, respectively, to prevent the flow of fluid from the conduits 156 and 166 to the plunger assembly 300 and wheel brakes 16a-d. Thus, the fluid within the first and second output pressure chambers 198 and 228 of the brake pressure unit 20 are fluidly locked which generally prevents the first and second output pistons 38 and 40 from moving further. More specifically, during the initial stage of the normal boost apply braking operation, movement of the input rod 45 causes movement of the input piston 34 in a rightward direction, as viewing FIG. 2. Initial movement of the input piston 34 causes movement of the primary piston 38 via the low rate simulator spring 108. Movement of the primary piston 38 causes initial movement of the secondary piston 40 due to the mechanical connection therebetween by the locking member 180 and the springs 188 and 190. Note that during this initial movement of the primary piston 38, fluid is free to flow from the primary pressure chamber 198 to the reservoir 18 via conduits 85, 154, and 68 until the conduit 85 moves past the seal 81. Also, during initial movement of the secondary piston 40, fluid is free to flow from the secondary pressure chamber 228 to the reservoir 18 via the conduits 155 and 164 until the conduit 155 moves past the seal 154.

After the primary and secondary pistons 38 and 40 stop moving (by closing of the conduits 85 and 155 and closing of the first and second base brake valves 320 and 322), the input piston 34 continues to move rightward, as viewing FIGS. 1 and 2, upon further movement by the driver depressing the brake pedal 42. Further movement of the input piston 34 compresses the various springs of the pedal simulator assembly 100, thereby providing a feedback force to the driver of the vehicle.

During normal braking operations (normal boost apply braking operation) while the pedal simulator assembly 100 is being actuated by depression of the brake pedal 42, the plunger assembly 300 can be actuated by the electronic control unit to provide actuation of the wheel brakes 16a-d. Actuation of the isolation valves 302 and 304 to their closed positions 302b and 304b isolated the brake pedal unit 12 from the wheel brakes 16a-d. The plunger assembly 300 may provide “boosted” or higher pressure levels to the wheel brakes 16a-d compared to the pressure generated by the brake pedal unit 12 by the driver depressing the brake pedal 42. Thus, the system 10 provides for assisted braking in which boosted pressure is supplied to the wheel brakes 16a-d during a normal boost apply braking operation helping reduce the force required by the driver acting on the brake pedal 42.

To actuate the wheel brakes 16a-d via the plunger assembly 300, the electronic control unit actuates the motor 352 in a first rotational direction to rotate the screw shaft 354 in the first rotational direction. Rotation of the screw shaft 354 in the first rotational direction causes the first piston 344 to advance in the actuation direction (leftward as viewing FIGS. 1 and 3). Movement of the first piston 344 causes the spring 380 to push against the second piston 346, thereby initiating movement of the second piston 346. Further movement of the first piston 344 also causes a pressure increase in the first pressure chamber 410 and fluid to flow out of the first pressure chamber 410 and into the conduit 324. Note that fluid is prevented from flowing into the conduit 308 from the first pressure chamber 410 due to the isolation valve 304 being in its closed position 304b. A pressure increase in the first pressure chamber 410 may also cause the second piston 412 to move in the actuation direction, thereby causing a pressure increase in the second pressure chamber 412. Fluid flows out of the second pressure chamber 412 through the conduit 320. Note that fluid is prevented from flowing into the conduit 306 from the second pressure chamber 412 due to the isolation valve 302 being in its closed position 302b. Pressurized fluid flowing into the conduits 320 and 324 and through the open control valves 310, 312, 314, and 316 causes actuation of the wheel brakes 16a-d via. Braking can be increased by advancing the first and second pistons via the screw shaft 354 of the ball screw mechanism 350.

When the driver releases the brake pedal 42, the pressurized fluid from the wheel brakes 16a-d may back drive the ball screw mechanism 350 moving the first and second pistons 344 and 346 back towards their rest position. Under certain circumstances, it may also be desirable to actuate the motor 352 to a second rotational direction opposite the first rotational direction to cause the first and second pistons 344 and 346 to move in a retraction direction (rightward as viewing FIGS. 1 and 3), thereby withdrawing the fluid from the wheel brakes 16a-d and replenishing the first and second pressure chambers 410 and 412. The motor 352 of the plunger assembly 300 may be actuated in the first and second rotational directions to provide an increase and decrease, respectively, in braking pressure at the wheel brakes 16a-d. All of the control valves 310, 312, 314, and 316 can be controlled (non-energized) to an open position to provide braking to all wheel brakes 16a-d simultaneously. Alternatively, as will be explained below, the control valves 310, 312, 314, and 316 can be actuated individually between their open and closed positions to provide different braking pressures within the wheel brakes 16a-d.

A stated above, the control valves 310, 312, 314, and 316 can be actuated individually between their open and closed positions to provide different braking pressures within the wheel brakes 16a-d. This may be used during various braking functions such as anti-lock braking, traction control, dynamic rear proportioning, vehicle stability control, hill hold, and regenerative braking. The plunger assembly 300 and the control valves 310, 312, 314, and 316 are operated by the electronic control unit (not shown). The plunger assembly 300 is preferably configured and operated by the electronic control unit (not shown) such that relatively small rotational increments of the motor 352 and/or ball screw mechanism 350 are obtainable. Thus, small volumes of fluid and relatively minute pressure levels are able to be applied and removed from the conduits 320 and 324. For example, the motor 352 may be actuated to turn 0.5 of a degree to provide a relatively small amount of fluid and pressure increase. This enables a multiplexing arrangement such that the plunger assembly 300 can be controlled to provide individual wheel pressure control. For example, if it is determined by the electronic control unit that the wheel brakes 16a and 16d require an increase in pressure to stabilize the vehicle, the control valves 310 and 316 can be actuated to their open positions. The remaining control valves 312 and 314 are actuated to their closed positions. The motor 352 of the plunger assembly 300 is then actuated to deliver the required pressure level to the wheel brakes 16a and 16d via the pressure chamber 412 and the conduits 320, 322 and 330. To maintain the pressure level within the wheel brakes 16a and 16d, the control valves 310 and 316 can be actuated to their closed positions. To decrease the pressure within the wheel brakes 16a and 16d, the motor 352 can be actuated into its opposite rotational direction and the control valves 310 and 316 are actuated accordingly. If during the event, the electronic control unit determines that different pressures are required in the wheel brakes 16a and 16d, the control valves 310 and 316 can be controlled individually to permit in increase or decrease in pressure via the conduits 310 and 330, respectively, as required. Thus, the plunger assembly 300 and the system 10 can be operated to provide individual control for the wheel brakes 16a-d or can be used to control one or more wheel brakes 16a-d simultaneously by opening and closing the appropriate control valves 310, 312, 314, and 316.

Although the system 10 is shown using single control valves 310, 312, 314, and 316 for each of the wheel brakes 16a-d, respectively, the system may be configured to include a pair of solenoid actuated control valves (not shown) for each of the wheel brakes 16a-d. Each pair of valves would be arranged in a parallel arrangement with respect to the conduits between the plunger assembly 300 and the respective wheel brake 16a-d. Thus, the illustrated system 10 would include eight control valves instead of the four control valves 310, 312, 314, and 316. The dual valves are controlled simultaneously between their open and closed positions. It may be more cost effective to have two smaller valves actuated simultaneously compared to having a single but larger control valve. To provide the generally same volume and pressure flow, the pair of valves may have smaller springs with lower spring rates compared to the single valve configuration. This may reduce the overall cost as well as being a quieter system since the solenoid required to overcome the bias of the springs may be smaller. For the dual control valve arrangement (not shown), the dual valves can be arranged within the system 10 such that the fluid flow through one of the dual valves is reversed relative to the other dual valve. The dual valves may include a valve seat arrangement in which flow can flow through the valve seat in either of two directions. In the first direction, the fluid flows first through the valve seat and around the ball or valve member. In the second direction, the fluid flows first around the ball or valve member and then through the valve seat. Although the dual valves may be generally identically structured, they may be situated within the housing of the hydraulic control unit 14 in a reversed manner. The use of a pair of dual valves having smaller spring rates with a reverse flow arrangement may provide better proportional control than a single larger spring valve. Proportional control is when a pressure increase or decrease is provided to more than wheel brake at a time, wherein the wheel brakes are at different pressures. Proportional control can be accomplished in the brake system 10 by using the plunger assembly 300 in cooperation with the respective control valve(s) for a first wheel brake, and then simultaneously using only control of the respective control valve(s) for a second wheel brake. The use of dual valves in a parallel arrangement may also prevent unwanted hydraulic braking in both directions of fluid flow.

In the event of a loss of electrical power to portions of the brake system 10, the brake system 10 provides for manual push through or manual apply such that the brake pedal unit 20 can supply relatively high pressure fluid to the primary output conduit 156 and the secondary output conduit 166. During an electrical failure, the motor 352 of the plunger assembly 300 might cease to operate, thereby failing to produce pressurized hydraulic brake fluid from the plunger assembly 300. The isolation valves 302 and 304 will shuttle (or remain) in their open positions 302a and 304a as shown in FIG. 1. In these positions, the isolation valves 302 and 304 permit fluid flow from the conduits 156 and 166 to the wheel brakes 16a-d through the plunger assembly 300. More specifically, fluid flow is permitted to flow from the primary output conduit 156 then through the open isolation valve 302, the conduit 306, the secondary pressure chamber 412, the conduit 320, the open control valves 310 and 316, the conduits 322 and 330, and to the wheel brakes 16a and 16d. Similarly, fluid flow is permitted to flow from the secondary output conduit 166 then through the open isolation valve 304, the conduit 308, the primary pressure chamber 410, the conduit 324, the open control valves 312 and 314, the conduits 326 and 328, and to the wheel brakes 16b and 16c. Thus, the brake pedal unit 20 may now provide a manual apply for energizing the conduits 320 and 324 for actuation of the wheel brakes 16a-d. The simulation valve 74 is shuttled to its closed position 74a, as shown in FIGS. 1 and 2, to prevent fluid from flowing out of the simulation chamber 144 to the reservoir 18. Thus, moving the simulation valve 74 to its closed position 74a hydraulically locks the simulation chamber 144 trapping fluid therein. During the manual push-through apply, the primary and secondary output pistons 38 and 40 will advance rightward pressurizing the chambers 198 and 228, respectively. Fluid flows from the chambers 198 and 228 into the conduits 156 and 166, respectively, to actuate the wheel brakes 16a-d as described above.

During the manual push-through apply, initial movement of the input piston 34 forces the spring(s) of the pedal simulator to start moving the pistons 38 and 40. After further movement of the input piston 34, in which the fluid within the simulation chamber 144 is trapped or hydraulically locked, further movement of the input piston 34 pressurizes the simulation chamber 144 causing movement of the primary piston 38 which also causes movement of the secondary piston 40 due to pressurizing of the primary chamber 144. As shown in FIGS. 1 and 2, the input piston 34 has a smaller diameter (about the seal 60) than the diameter of the primary piston 38 (about the seal 80). Since the hydraulic effective area of the input piston 34 is less than the hydraulic effective area of the primary piston 38, the input piston 34 may travel more axially in the right-hand direction as viewing FIGS. 1 and 2 than the primary piston 38. An advantage of this configuration is that although a reduced diameter effective area of the input piston 34 compared to the larger diameter effective area of the primary piston 38 requires further travel, the force input by the driver's foot is reduced. Thus, less force is required by the driver acting on the brake pedal 42 to pressurize the wheel brakes compared to a system in which the input piston and the primary piston have equal diameters.

In another example of a failed condition of the brake system 10, the hydraulic control unit 12 may fail as discussed above and furthermore one of the output pressure chambers 198 and 228 may be reduced to zero or reservoir pressure, such as failure of a seal or a leak in one of the conduits 156 or 166. The mechanical connection of the primary and secondary pistons 38 and 40 prevents a large gap or distance between the pistons 38 and 40 and prevents having to advance the pistons 38 and 40 over a relatively large distance without any increase in pressure in the non-failed circuit. For example, if the brake system 10 is under a manual push through mode and additionally fluid pressure is lost in the output circuit relative to the secondary piston 40, such as for example in the conduit 166, the secondary piston 40 will be forced or biased in the rightward direction due to the pressure within the primary chamber 198. If the primary and secondary pistons 38 and 40 were not connected together, the secondary piston 40 would freely travel to its further most right-hand position, as viewing FIGS. 1 and 2, and the driver would have to depress the pedal 42 a distance to compensate for this loss in travel. However, because the primary and secondary pistons 38 and 40 are connected together through the locking member 180, the secondary piston 40 is prevented from this movement and relatively little loss of travel occurs in this type of failure. Thus, the maximum volume of the primary pressure chamber 198 is limited had the secondary piston 40 not be connected to the primary piston 38.

In another example, if the brake system 10 is under a manual push through mode and additionally fluid pressure is lost in the output circuit relative to the primary piston 40, such as for example, in the conduit 156, the secondary piston 40 will be forced or biased in the leftward direction due to the pressure within the secondary chamber 228. Due to the configuration of the brake pedal unit 20, the left-hand end of the secondary piston 40 is relatively close to the right-hand end of the primary piston 38. Thus, movement of the secondary piston 40 towards the primary piston 38 during this loss of pressure is reduced compared to a conventional master cylinder in which the primary and secondary pistons have equal diameters and are slidably disposed in the same diameter bore. To accomplish this advantage, the housing 24 of the brake pedal unit 20 includes a stepped bore arrangement such that diameter of the second bore 28 which houses the primary piston 38 is larger than the third bore 30 housing the secondary piston 40. A portion of the primary chamber 198 includes an annular region surrounding a left-hand portion of the secondary piston 40 such that the primary and secondary pistons 38 and 40 can remain relatively close to one another during a manual push-through operation. In the configuration shown, the primary and secondary pistons 38 and 40 travel together during a manual push-through operation in which both of the circuits corresponding to the conduits 156 and 166 are intact. This same travel speed is due to the hydraulic effective areas of the pistons 38 and 40, for their respective output pressure chambers 198 and 228, are approximately equal. In a preferred embodiment, the area of the diameter of the secondary piston 40 is approximately equal to the area of the diameter of the primary piston 38 minus the area of the diameter of the secondary piston 40. Of course, the brake pedal unit 20 could be configured differently such that the primary and secondary pistons 38 and 40 travel at different speeds and distances during a manual push though operation.

During a manual push-through operation in which both of the circuits corresponding to the conduits 156 and 166 are intact, such as during an electrical failure described above, the combined hydraulic effective area of the primary and secondary pistons 38 and 40 is the area of the diameter of the primary piston 38. However, during a failure of one of the circuits corresponding to the conduits 156 and 166, such as by a leak in the conduit 166, the hydraulic effective area is halved such that the driver can now generate double the pressure within the primary chamber 198 and the non-failed conduit 156 when advancing the primary piston 38 during a manual push-through operation via depression of the brake pedal 42. Thus, even though the driver is actuating only two of the wheel brakes 16a and 16d during this manual push through operation, a greater pressure is obtainable in the non-failed primary chamber 198. Of course, the stroke length of the primary piston 38 will need to be increased to compensate.

The plunger assembly 300 also includes features to assist during certain failed conditions. The extension 370 and the enlarged head 372 of the first piston 344 and the extension 390 and enlarged head 392 of the second piston 346 restrict the movement of the second piston 346 relative to the first piston 344. Rearward travel of the second piston 346 is also limited by the connection of the enlarged head 392 to the housing 340. This configuration limits the maximum volume of the first and second pressure chambers 410 and 412. This restriction in movement may be useful during a downstream failed condition in which one of the circuits corresponding to the conduits 320 and 324 leaks. For example, in a detected failed condition in which fluid within one or more of the conduits 320, 322, and 330 leaks, the electronic control unit may enter into a manual push-through mode such that the isolation valves 302 and 304 are actuated to their open positions and the brake pedal unit 20 is used to provide pressure within the output conduits 156 and 166. In this manual push-through situation, fluid flows through the pressure chambers 410 and 412 of the plunger assembly 300. In this example of a failed condition, fluid is leaking from the conduit 320. The configuration of the plunger assembly 300 prevents the first pressure chamber 410 from expanding due to its increase in pressure relative to the second pressure chamber 412 associated with the leak. If the secondary piston 346 was not mechanically connected and permitted to move, the first pressure chamber 410 would expand and the pistons of the brake pedal unit 20 would need to be advanced to accommodate the expanding first pressure chamber 410, thereby causing loss pedal travel experienced by the driver. Similarly, a failed condition in which fluid within one or more of the conduits 324, 326, and 328 leaks, a loss in pressure within the first pressure chamber 410 would occur. The extension 390 and the enlarged head 392 prevents appreciable retraction of the second piston 346 in the retraction direction (rightward as viewing FIGS. 1 and 3) due to the greater pressure within the second pressure chamber 412 relative to the first pressure chamber 410.

During a normal boost apply operation of the system 10 in which the plunger assembly 300 is supplying pressure to one of the conduits 320 and/or 324, the first and second pistons 344 and 346 will have been advanced in the actuation direction by the ball screw assembly 350. If a failure occurs under this condition in which the electronic control unit enters the system 10 into a manual push-through mode, the isolations valves 302 and 304 may be de-energized from a closed position to an open position. When the isolation valves 302 and 304 are moved into their open positions, the pressure within the first and second pressure chambers 410 and 412 would either cause the ball screw assembly 350 to back drive such that the first piston 344 is moved in the retraction direction (rightward as viewing FIGS. 1 and 3) or cause the pressure within the conduits 156 and 166 to force the pistons of the brake pedal unit 20 rearwardly forcing the pedal 42 rearwardly as well. The driver may compensate for the back driven ball screw mechanism 350 by further pressing on the pedal 42 to advance the pistons of the brake pedal unit 20, thereby compensating for this lost travel. Although this may be very acceptable during such a failed condition, the valve components of the isolation valves 302 and 304 could be configured to hydraulically lock during this situation to prevent rearward movement of the pistons of the brake pedal unit 20 even though the isolation valves 302 and 304 are de-energized. Thus, even in an electrical shut down of the system 10 during a normal boost apply mode, the isolation valves 302 and 304, which would be de-energized to their normally open positions, would remain in an internally closed condition (hydraulically locked) such that the internal valves of the isolation valves 302 and 304 would prevent fluid from flowing from the first and second chambers 410 and 412 into the conduits 156 and 166. Thus, this built up in pressure within the plunger assembly 300 would not initially force the pistons of the brake pedal unit 20 rearwardly forcing the pedal 42 rearwardly as well. The isolation valves 302 and 304 could also be configured such that when the driver depresses the pedal 42 to generate pressure within the brake pedal unit 20 during a manual push-though mode, the increase in pressure within the conduits 156 and 166 opens the internal valves of the isolation valves 302 and 304 permitting flow into the wheel brakes 16a-d such as during normal manual push-though operation described above. Preferably, the isolation valves 302 and 304 are configured such that they will not hydraulically lock under other conditions such as during a spike or rapid apply. Thus, the isolation valves 302 and 304 may be configured such that a low pressure level acting on the valves 302 and 304 will unlock the valves from their temporary hydraulic lock condition.

There is schematically illustrated in FIG. 4 a second embodiment of a vehicle brake system, indicated generally at 500. Similar to the above described brake system 10, the brake system 500 may suitably be used on a ground vehicle such as an automotive vehicle having four wheels and a wheel brake for each wheel. Furthermore, the brake system 500 can be provided with other braking functions such as anti-lock braking (ABS), other slip control features, and regenerative braking blending to effectively brake the vehicle. The brake system 500 is similar in function and structure of some aspects of the brake system 10 and, therefore, like numbers and/or names may be used to reference similar components.

Similar to the brake system 10, the brake system 500 includes a brake pedal unit assembly, indicated by broken lines 12, including a brake pedal unit 20, reservoir 18, brake pedal 42, and simulation valve 74 which are similar in function and structure as describe above with respect to the brake system 10. The brake system 500 also includes wheel brakes 16a-d, first and second isolation valves 302 and 304, and control valves 310, 312, 314, and 316 which are similar in function and structure as described above with respect to the brake system 10. The components located out of the brake pedal unit assembly 12 may be housed in a hydraulic control unit housing or may be located remotely from one another.

The brake assembly 500 further includes a plunger assembly, indicated generally at 502. Although the plunger assembly 502 is similar to the plunger assembly 300 described above with respect to the brake system 10, there are some differences that will be described below. As best shown in FIG. 5, the plunger assembly 502 includes a housing 540 having a bore 542 formed therein. Slidably disposed in the bore 542 are first and second pistons 544 and 546, respectively. The plunger assembly 502 further includes a ball screw mechanism, indicated generally at 550. The ball screw mechanism 550 is provided to impart translational or linear motion of the first piston 544 along an axis defined by the bore 542 in both an actuation direction (downward as viewing FIGS. 4 and 5), and a retraction direction (upward as viewing FIGS. 4 and 5) within the bore 542 of the housing 540. In the embodiment shown, the ball screw mechanism 550 includes a motor 552 rotatably driving a screw shaft 554. A motor 552 may include a sensor 553 for detecting the rotational position of the motor 552 and/or ball screw mechanism 550 which is indicative of the position of the first piston 544. This may be particular useful for a motor 552 which is capable of very accurate control including controlling the motor to minute movements for providing multiplex control as will be described below. The first piston 544 includes a threaded bore 556 and functions as a driven nut of the ball screw mechanism 550. The ball screw mechanism 550 includes a plurality of balls 558 that are retained within helical raceways formed in the screw shaft 554 and the threaded bore 556 of the first piston 544 to reduce friction.

The first piston 544 includes an outer cylindrical surface 560. A seal, or O-ring 562, is mounted within a groove 564 formed in the bore 542. A lip seal 566 is mounted within a groove 568 formed in the bore 542. The O-ring 562 and the lip seal 566 sealingly engage with the outer cylindrical surface 560 of the first piston 544. The first piston 544 includes a pin or an extension 570 extending towards the second piston 546. The extension 570 includes an enlarged head 572. The enlarged head 572 is trapped within a cavity 574 formed in the second piston 556 by an inwardly extending flange 576. The first piston 544 is mechanically connected to the second piston 546 by the cooperation of the extension 570 and the flange 576 while still permitting a predetermined amount of movement therebetween. The first piston 544 is biased in a direction away from the second piston 546 by a spring 580. The spring 580 generally acts on end surfaces of the pistons 544 and 546 which face one another. The spring 580 can be generally housed within a recess 582 formed in the first piston 544.

The second piston 546 includes an outer cylindrical surface 584. An O-ring 586 is mounted within a groove 587 formed in outer cylindrical surface 584 of the second piston 546. The O-ring 586 sealingly engage with the wall of the bore 542. Instead of having a pin or an extension, the second piston 546 is limited in its travel by an outwardly extending flange 590 positioned and trapped within a recess 592 formed in the bore 542. The recess 592 defines a pair of shoulders 593 and 594 which may engage with the flange 590 of the second piston 546 to mechanically connect the second piston 546 to the housing 540 while still permitting a predetermined amount of movement therebetween. The second piston 546 is biased in a direction away from the end of the bore 550, and towards the first piston 544, by a spring 600. The springs 580 and 600 generally position the second piston 546 relative to the first piston 544 within the bore 542. The springs 580 and 600 also function as return springs by biasing the first and second pistons 544 and 546 into their rest positions as shown in FIGS. 4 and 5.

The plunger assembly 502 includes a first pressure chamber 610 and a second pressure chamber 612. The first pressure chamber 610 is generally defined by the bore 540, the first and second pistons 544 and 546, the lip seal 566, and the O-ring 586. The first pressure chamber 610 communicates with a conduit 324a which is in fluid communication with the conduit 324. The second pressure chamber 612 is generally defined by the bore 540, the second piston 546, and the O-ring 586. The second pressure chamber 612 communicates with a conduit 320a which is in fluid communication with the conduit 320. Unlike the plunger assembly 300, adjacent areas of the seals of the plunger assembly 502 are not vented or in fluid communication with the reservoir 18.

The brake system 500 operates similarly as the system 10 described above. To actuate the wheel brakes 16a-d via the plunger assembly 502, the electronic control unit actuates the motor 552 in a first rotational direction to rotate the screw shaft 554 in the first rotational direction. Rotation of the screw shaft 554 in the first rotational direction causes the first piston 544 to advance in the actuation direction (downward as viewing FIGS. 4 and 5) causing initial movement of the second piston 612 by the spring 570. Movement of the first piston 544 causes a pressure increase in the first pressure chamber 610 and fluid to flow out of the first pressure chamber 610 and into the conduit 324a. Note that fluid is prevented from flowing into the secondary output conduit 166 from the first pressure chamber 610 due to the isolation valve 304 being in its closed position. A pressure increase in the first pressure chamber 610 will also cause the second piston 612 to move in the actuation direction, thereby causing a pressure increase in the second pressure chamber 612. Fluid flows out of the second pressure chamber 612 through the conduit 320a. Note that fluid is prevented from flowing into the conduit 320 from the second pressure chamber 612 due to the isolation valve 302 being in its closed position. Pressurized fluid flowing into the conduits 320 and 324 and through the open control valves 310, 312, 314, and 316 causes actuation of the wheel brakes 16a-d via. Similar to the brake system 10, braking can be increased by advancing the first and second pistons 544 and 546 via the screw shaft 554 of the ball screw mechanism 550. To reduce pressure within the wheel brakes 16a-d, the motor 552 is actuated to a second rotational direction opposite the first rotational direction to cause the first and second pistons 544 and 546 to move in a retraction direction (upward as viewing FIGS. 1 and 3), thereby withdrawing the fluid from the wheel brakes 16a-d and replenishing the first and second pressure chambers 610 and 612. The motor 552 of the plunger assembly 502 may be actuated in the first and second rotational directions to provide an increase and decrease, respectively, in braking pressure at the wheel brakes 16a-d. All of the control valves 310, 312, 314, and 316 can be controlled (non-energized) to an open position to provide braking to all wheel brakes 16a-d simultaneously. Alternatively, the control valves 310, 312, 314, and 316 can be actuated individually between their open and closed positions to provide different braking pressures within the wheel brakes 16a-d.

Similar to the plunger assembly 300, the plunger assembly 502 includes features to assist during certain failed conditions such as limiting the maximum volume of the first and second pressure chambers 410 and 412. In a failed condition in which fluid within the conduit 324a leaks, a loss in pressure within the first pressure chamber 610 would occur. The cooperation of the flange 590 and the shoulder 593 of the recess 592 prevents appreciable retraction of the second piston 346 in the retraction direction (upward as viewing FIGS. 4 and 5) due to the greater pressure within the second pressure chamber 612 relative to the first pressure chamber 610.

One of the advantages of the plunger assembly 502 compared to the plunger assembly 300 is the reduced number of seals. The plunger assembly 300 includes four seals 362, 366, 386, and 388 compared to the three seals 562, 566, and 586 of the plunger assembly 502. With a lower number of seals, the overall length of the plunger assembly 502 may be reduced. Another advantage is that at higher pressures within the plunger assembly, the fewer number of seals may reduce friction. Friction is also reduced because the delta pressure across a seal on the secondary piston is reduced during normal boos operation.

Another difference between the plunger assemblies 300 and 502 is that the plunger assembly 300 includes a conduit 296 connecting the reservoir 18 to the plunger assembly 300. The conduit 296 branches into a pair of conduits such that a gap between the O-ring 362 and the lip seal 366 and a gap between the O-ring 386 and the lip seal 388 are in fluid communication with the reservoir 18 via the conduit 296. With this configuration, it may be easier to detect a failure of one of the seals of the plunger assembly 300 as compared to the plunger assembly 502. The conduit 296 allows failure detection during normal boos operation by determining abnormal travel which is out of sync with anticipated pressure. During non-braking events, the electronic control unit may perform testing on the system 10 to detect a failure of the seals by monitoring the abnormal fluid flow into the conduit 296 past a failed seal within the plunger assembly 300.

There is illustrated in FIGS. 6 and 7 a third embodiment of a plunger assembly, indicated generally at 700. The plunger assembly 700 is similar in structure and function as the plunger assemblies 300 and 502. One of the differences is that the plunger assembly 700 includes a hollow outer sleeve 702 which is mounted within a bore 704 of a housing 706. First and second pistons 744 and 746 are slidably mounted in a stepped inner bore of the outer sleeve 702, as will be discussed below. The outer sleeve 702 may be helpful for bleeding and evacuation purposes of the plunger assembly 700 compared to a plunger assembly having first and second pistons mounted in a bore of the housing. If the housing 706 were made of aluminum, a separate sleeve 702 made of a hard coat anodized material may be desirable for housing the first and second pistons 744 and 746. The sleeve 702 may also assist in assembly due to the stepped bore design. As will be described below, one of the advantages of the plunger assembly 700 is that the pistons 744 and 746 and associated pressure chambers are arranged in an overlapping manner which helps reduce the overall length of plunger assembly 700.

The plunger assembly 700 further includes a ball screw mechanism, indicated schematically at 750. The ball screw mechanism 750 is provided to impart translational or linear motion of the first piston 744 along an axis defined by the bore 704 in both an actuation direction (leftward as viewing FIGS. 1 and 3), and a retraction direction (rightward as viewing FIGS. 1 and 3). In the embodiment shown, the ball screw mechanism 750 includes a motor (not shown) driving an actuator 754. The actuator 754 may be prevented from rotation by an anti-rotation device including a pair of rollers 714 translating in corresponding tracks 716, as shown in FIG. 6. Thus, the actuator 754 is moved in a liner manner by the ball screw mechanism 750. The actuator 754 engages a retainer 720 which is threadably connected to an end of the first piston 744. The retainer 720 includes a seal 722 for sealing off the interior of the first piston 744 relative to the ball screw mechanism 750.

The first piston 744 includes an outer cylindrical surface 760. Pair of seals 762 and 766 is mounted on the outer sleeve 702 and sealingly engage with the surface 760 of the first piston 744. The plunger assembly 700 also includes a mechanical coupling to the second piston 746 via a caged spring assembly, indicated generally at 747. The caged spring assembly 747 includes an extension pin 770 threadably connected to the end of the second piston 746 and having an enlarged head 772 engaged and trapped by an inwardly extending flange 774 of the first piston 744. A spring 780 biases the second piston 746 in a direction away from the first piston 744.

The second piston 746 includes an outer cylindrical surface 784. An O-ring 786 is mounted on the second piston 746. A caged spring assembly, indicated generally at 789, includes an extension pin 790 threadably connected to the second piston 746 and having an enlarged head 792 engaged and trapped by a retainer 796 disposed in the end of the bore 704. A spring 800 biases the retainer 796 away from the second piston 746 by a predetermined distance.

The plunger assembly 700 includes a first pressure chamber 810 and a second pressure chamber 812. The first pressure chamber 810 includes an expanding and contraction portion generally disposed around the outer surface of the second piston 746 to help reduce the length of the plunger assembly 700. The first pressure chamber 810 can communicate with the conduit 324a, such as for the system 500 shown in FIG. 4, via passageways 813 formed through the outer sleeve 702. The second chamber 812 can communicate with the conduit 320a, such as for the system 500, via slots 815 formed in the retainer 796.

The outer sleeve 702 includes first bore portion 703 and a second bore portion 705. The first bore portion 703 is defined by a diameter D₁ which is slightly smaller than the diameter D₂ of the second bore portion 705. This configuration of the outer sleeve 702 enables communication between the primary chamber 810 and the conduit 324a even during long stroke lengths of the first piston 744, as shown in FIG. 7, wherein the end of the first piston 744 moves past the passageways 813.

The caged spring assemblies 747 and 789 limit the maximum volume of the first and secondary pressure chambers 810 and 812, respectively, thereby reducing travel in certain types of failure conditions such as discussed above with respect to the other plunger assemblies described and shown herein.

There is illustrated in FIG. 8 a fourth embodiment of a plunger assembly, indicated generally at 900. The plunger assembly 90 is similar in structure and function as the plunger assemblies described above. The plunger assembly 900 includes a housing 902 having a bore 904 formed therein. First and second pistons 910 and 912 are slidably disposed in the bore 904 for generating pressure within first and second pressure chambers 920 and 922, respectively. The bore 904 includes a pair of slot portions 906 to provide fluid communication between the first and second pressure chambers 920 and 922 and conduits 930 and 932, respectively. The conduits 930 and 932 can be in fluid communication with the wheel brakes of a brake system shown and described above with respect to other plunger assemblies described herein. The slots 906 also provide flow paths from the reservoir ports to the pressure chambers past the recuperating lip seals.

The plunger assembly 900 may also included caged spring assemblies 936 and 938, for limiting the maximum volume of the first and secondary pressure chambers 920 and 922. The plunger assembly 900 may further includes a threaded cap 942 threadably connected to a retainer 944 of the caged spring assembly 938 for sealing off an opening 943 of the end of the bore 904 via a seal 946. The removable cap 942 permits installation of various components of the plunger assembly 900 through the opening 943 as well as permitting access for threading various components together during installation, such as for example the caged spring assembly 938. The plunger assembly 900 can be pre-assembled and slid into the bore. The opening 943 provides an access hole to adjust the threaded connection at the end of the bore. The cap 942 seals the opening 943 and locks the threaded connection in place.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A brake system comprising:
first and second wheel brakes;
a brake pedal unit including a housing and a pair of output pistons slidably disposed in said housing, wherein said pair of output pistons are movable to generate brake actuating pressure at first and second outputs for actuating said first and second wheel brakes, respectively, during a manual push through mode; and
a plunger assembly for actuating said first and second wheel brakes during a normal brake apply, wherein said plunger assembly includes:
a housing;
a motor mounted on said housing for driving an actuator;
a first piston connected to said actuator, said first piston slidably mounted within said housing for pressurizing a first fluid chamber in said housing, wherein said first fluid chamber is in communication with said first wheel brake; and
a second piston slidably mounted within said housing for pressurizing a second fluid chamber in said housing, wherein said second fluid chamber is in communication with said second wheel brake;
a pump-less control valve arrangement including:
a first control valve regulating the flow of fluid between said first fluid chamber and said first wheel brake, and
a second control valve regulating the flow of fluid between said second fluid chamber and said second wheel brake; and
an isolation valve arrangement for switching the brake system between the normal braking mode wherein boost pressure from the plunger assembly is supplied to the wheel brakes, and the manual push-through mode wherein brake actuating pressure from the brake pedal unit is supplied to the wheel brakes.

2. The system of claim 1, wherein said motor is operable to drive said actuator in a reverse direction to supply fluid into said first and second fluid chambers of said plunger assembly.

3. The system of claim 1 further including an electronic controller providing multiplex control to said first and second control valves to control the pressures at each of the first and second wheel brakes independently from one another.

4. A plunger assembly for use as a pressure source for a brake system, said plunger assembly comprising:
a housing;
a motor mounted on said housing for driving an actuator;
a first piston connected to said actuator, said first piston slidably mounted within said housing for pressurizing a first fluid chamber in said housing, wherein said first fluid chamber is in communication with said first wheel brake; and
a second piston slidably mounted within said housing for pressurizing a second fluid chamber in said housing, wherein said second fluid chamber is in communication with said second wheel brake,
wherein said first and second pistons are arranged in an overlapping manner.
